(19) United States
(12) Patent Application Publication
(10) Pub. No.: US 2019/0392498 A1
(43) Pub. Date: Dec. 26, 2019

(54) RECOMMENDATION ENGINE AND SYSTEM

(71) Applicant: SAP SE, Walldorf (DE)

(72) Inventors: Mridul Sarkar, Bangalore (IN); Kumar Nitesh, Bangalore (IN)

(21) Appl. No.: 16/017,399

(22) Filed: Jun. 25, 2018

(51) Int. Cl. G06Q 30/06; G06K 9/00

(52) U.S. Cl. CPC G06Q 30/0613; G06Q 30/0631; G06K 9/00483

(57) ABSTRACT

A method and system including receiving a first set of document files comprising textual terms relating to a plurality of first users; receiving a second set of document files relating to a second user from one or more data sources, the second set of document files including a plurality of textual terms associated with the second user from a combination of documents; determining whether the second set of document files is similar to one or more documents in the first set of document files based on a collaborative filtering process of the textual terms derived from the second set of document files and the first set of document files; generating an indicator that indicates a level of similarity between the second set of document files and the one or more documents in the first set of document files; and outputting a user interface displaying the generated indicator.

### BACKGROUND

The present disclosure herein generally relates to a recommendation engine and, more particularly, to systems and methods to provide a recommendation to a user based on a diverse set of inputs related to the user and others, including generating notifications related thereto.

### BRIEF DESCRIPTION OF THE DRAWINGS

FIG. 1 is an illustrative depiction of a query response document related to a user, according to some embodiments;

FIG. 2 is an illustrative depiction of a first transaction document related to a user, according to some embodiments;

FIG. 3 is an illustrative depiction of a second transaction document related to a user, according to some embodiments;

FIG. 4 is an illustrative flow diagram of a process, according to some embodiments;

FIG. 5 is an illustrative depiction of a system architecture, according to some embodiments;

FIG. 6 is an illustrative system block diagram, according to some embodiments; and

FIG. 7 is a block diagram of an apparatus, according to some embodiments.

### DETAILED DESCRIPTION

The following description is provided to enable any person in the art to make and use the described embodiments. Various modifications, however, will remain readily apparent to those in the art.

In some aspects of the present disclosure, one embodiment includes a method to automatically generate a recommendation for a user. In some instances, the user might be a supplier and the recommendation may include a lead, invitation, or introduction to a buyer or other entity that might be interested in interacting with the user. In one illustrative scenario, the supplier (e.g., a first user) and a number of buyers may communicate with each other via a computer-implemented professional or social network. The network may include a plurality of different software and hardware components, including but not limited to, a number of different applications, services, devices from one or more vendors and/or service providers configured to support and facilitate communication between the first user and the second set of users. In some aspects, the network may be equipped to safely and securely transport, process, and store communications between the entities communicating on the network.

In accordance with some embodiments herein, the present disclosure includes an intelligent and efficient method and system of generating relevant and compatible recommendations for a user. The systems and methods herein may be used to generate highly compatible and relevant recommendations or leads to a user (e.g., a supplier), where the characteristics of the user strongly correlate with requirements of other users (e.g., buyers) they may be matched with according to the generated recommendation.

The present disclosure will be discussed using one or more illustrative examples, use-cases, and contexts. However, the functionalities disclosed herein are not strictly limited to illustrative examples and contexts and have applicability to a wide variety of other contexts, use-cases, and applications.

In one instance, a method and system herein are configured to generate and provide recommendations (e.g. leads) to a supplier, where the supplier is enrolled on a computer-implemented professional network. The network, based on the number of user suppliers enrolled therein, has access to and manages a large quantity and variety of data documents related to the network's users. In some aspects, the network has access to data specific to a variety of document files, where a document file herein refers to data derived from one or more documents related to a user, whether the initial document is a physical document or an electronic representation of the data. In some instances, the document files might include a purchase order (PO), an invoice, a request for information (RFI) document, a request of quote (RFQ) document, a contract or other agreement, a user profile document, and other types of document files. IN some embodiments, the document files and data derived therefrom may be represented as database tables or other data structures (e.g., graphs, etc.). In some embodiments, the database tables may include an aggregation of data for a plurality of different users. The data items in the database tables typically include at least one identifier or key that can be used to identify, sort, query, and otherwise manage the data based on the specific user related to the given data items.

A recommendation engine herein may receive input data comprising an input dataset from multiple data sources. The data sources may include data storage facilities, streaming data sources, and combinations thereof. In one embodiment, the input dataset may include a set of document files including a plurality of textual terms associated with the user from a combination of documents including a user profile document that can be configured by the user, a query response document that might be configured by the user, an interaction document capturing a transaction involving the user, an interest level document, and a similarity level document. The document files may be represented and configured as database tables, stored in one of more data structures and managed by a database management system. A database herein may implement an “in-memory” database, in which a full database is stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

In some embodiments, a user profile document herein configured by a user might include a collection or listing of commodities and services offered or supplied by a user (e.g., supplier), as well as the region(s) in which the user can supply their commodities and services. While a complete and accurate user profile is desired, some embodiments herein recognize that a user might not provide a user profile that is complete in its disclosure and/or is not fully accurate. Accordingly, the present disclosure does not strictly rely on a user configured user profile.

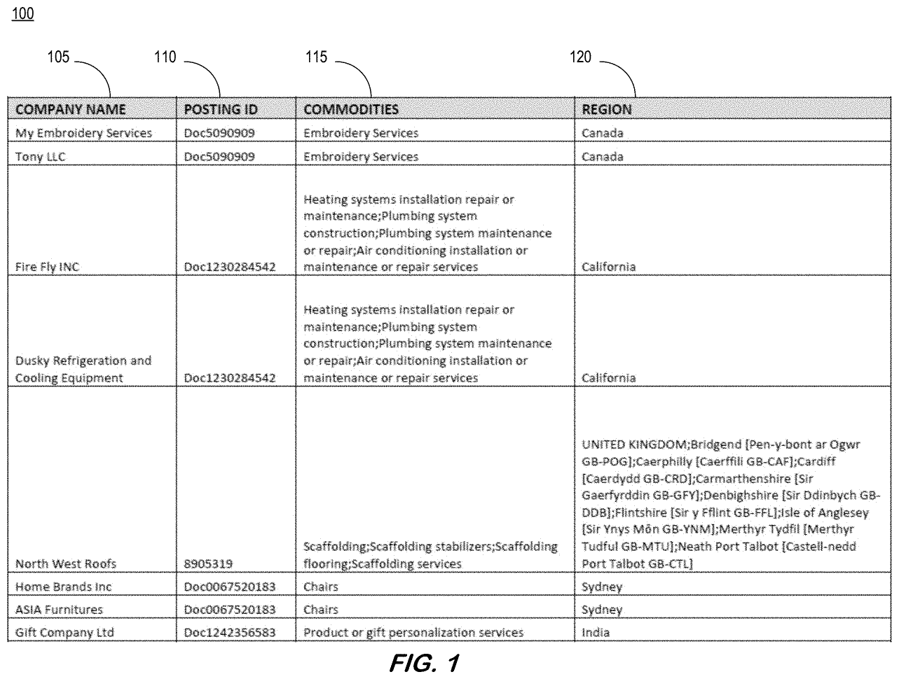

In some embodiments, a query response document configured by a user might include, for example, responses the user previously provided to prior inquiries or invites (e.g., business leads). The network may have archived records of the user's prior inquiries or invites. FIG. 1 is an illustrative depiction of a document file 100 of user responses to prior inquiries regarding the services and commodities provided and the corresponding regions served by the users. As seen, document 100 includes a table listing a number of records (i.e., rows), where the records are organized based on, for example, the user's name 105, a network posting identifier for the record 110, the commodities (or services) 115 provided by the user, and the geographical region 120 serviced by the user.

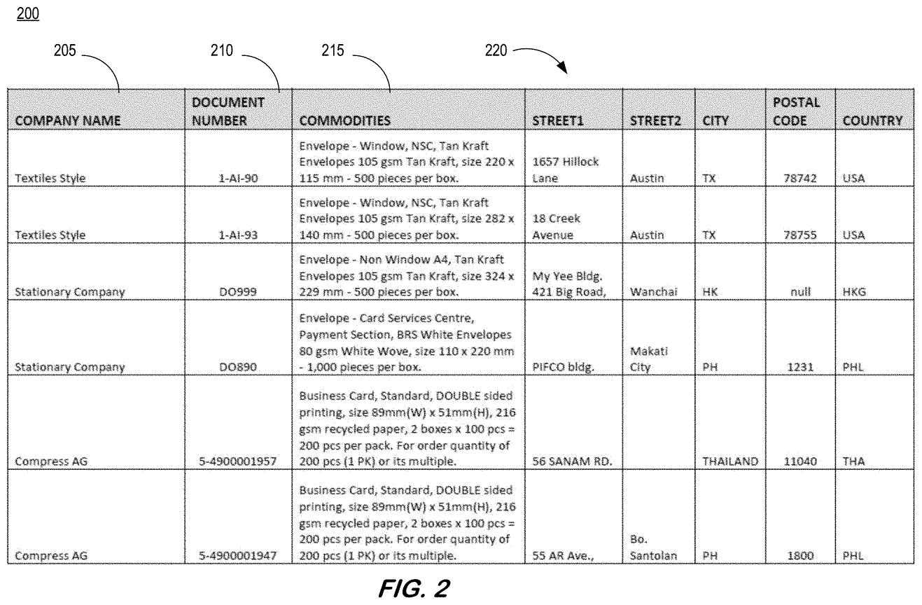

In some embodiments, an interaction document might include, for example, a document capturing a transaction involving the user, such as, for example documents used in actual transactions involving the user. FIG. 2 is an example of an interaction document 200 that includes transaction details from transactions involving users (e.g., companies) 205. The data values on the interaction document may be obtained or otherwise derived from a purchase order and/or invoice document. Other details relating to the users shown at 205 include a document identifier 210 for the purchase order or invoice record, the commodities (or services) 215 actually exchanged in the transaction, and the geographical location 220 where the commodities/services were delivered.

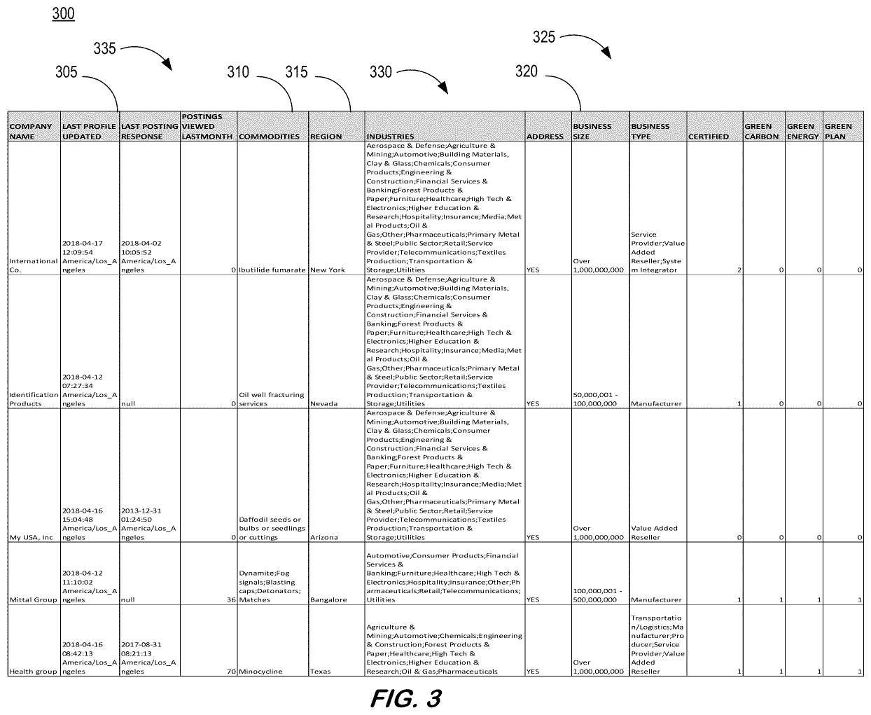

FIG. 3 is a further example of an interaction document 300 that includes transaction details. In particular, interaction document 300 includes details relating to users (e.g., companies) 305. The data values in interaction document 300 may be obtained or otherwise derived from responses provided by the users (e.g., companies) 305 in reply to a request for quotation (RFQ). Other details relating to the users shown at 305 can include the commodities (or services) 310 the user stated they can provide, the geographical location 315 where the commodities/services can be rendered, the user's size 320, and other details 325, 330, and 335 related to the user as shown in document 300.

In some embodiments other documents and document files such as, for example, an interest level document and a similarity level document might be used as an input to a recommendation engine herein. In some instances, the interest level document might include a listing or collection of one or more potential contacts (e.g., business leads) being considered by a user. For example, the potential contacts may have been identified in the network by the user and placed on a “watch list” by the user, even though the user has not contacted them. Placement on the “watch list” by a user may be considered and interpreted as a potential relevant match for the user.

In some embodiments, a similarity level document includes an indication of other users that may be similar to a user, based on the other users' network profile being similar to a subject user's network profile. For example, a new user might be compared and likened to other users already enrolled in the network on the basis of locations served, commodities/services offered, size of user, etc. and combinations thereof. However, since a user configured profile might not be fully complete or accurate, this type of document alone is not used by a recommendation engine herein.

Combinations of these different types and varieties of input data may be received and used by a recommendation engine herein. In some instances, each type of document file might not be available for a user. For example, an interaction document including actual transaction details might not be available for a new user to a network. However, some embodiments herein will use the different types and varieties of input data related to a given user, to the extent that it exists and is accessible by the network and systems herein. In some aspects, the combination of the different types and varieties of input data provides a diverse basis for a recommendation engine herein to generate recommendations based on actual user preferences, interactions, and demonstrated preferences.

In some aspects, the combination of the different types and varieties of input data used by a recommendation engine disclosed herein may be used to build a “virtual profile” for a supplier. The virtual profile is separate and distinct from a user supplied profile, as it is not limited to the reporting veracity and completeness of the user's responses.

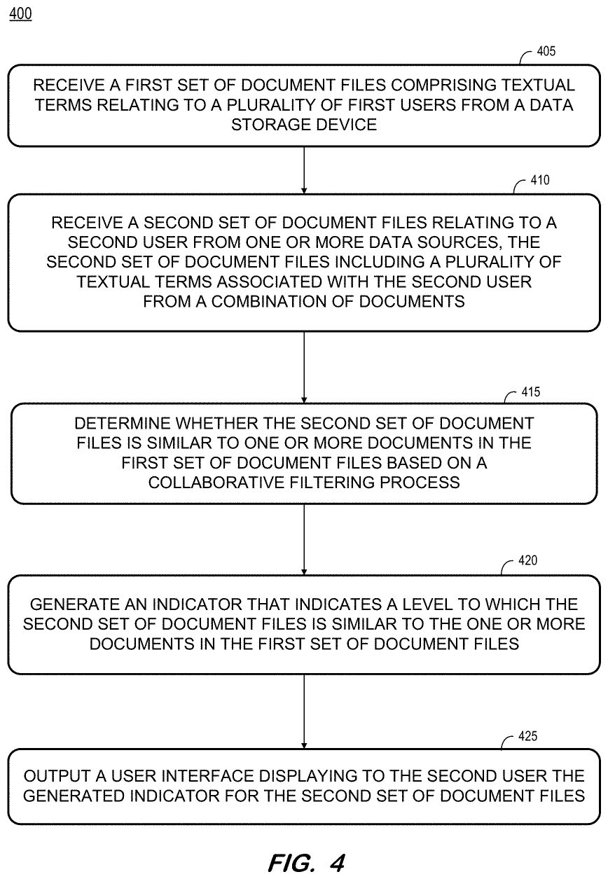

FIG. 4 is an illustrative flow diagram of a process relating to some embodiments herein. At operation 405, a first set of document files comprising textual terms relating to a plurality of first users is received from a data storage device. The storage device may include a data store facility, a data warehouse, and a database management system. In the present example, the plurality of first users refers to a set of users enrolled in a network for which the network (i.e., system, service, or platform) has access to historical data relating to the plurality of first users. The first set of document files comprising textual terms relating to a plurality of first users can include all of the types and varieties of documents mentioned hereinabove.

At operation 410 a second set of document files relating to a second user is received from one or more data sources, the second set of document files include a plurality of textual terms associated with the second user from a combination of documents including, for example, a user profile document, a query response document, an interaction document, an interest level document, and a similarity level document. In some instances, each of the document file types or data derived therefrom might not be available, however process 200 can proceed with the extent and variety of data it can obtain for the second user. In this example, the second user (e.g., a supplier) is the entity for which a recommendation is being generated.

At operation 415, a determination is made regarding whether the second set of document files is similar to one or more documents in the first set of document files based on a collaborative filtering process of the textual terms derived from the second set of document files in combination with the textual terms of the first set of document files. The document files may capture and represent a user's actions, qualifications, and preferences and the collaborative filtering process operates to calculate a prediction of the second user's preference(s) based on a similarity with certain specific users of the first plurality of users. The collaborative filtering process(es) may operate on the premise that entities that agreed in the past will agree in the future, as well as having similar preference(s) for like items. For example, if user A prefers items 1, 2, and 3 and user B prefers items 2, 3, and 4, then user A and B will have similar preferences and user A will also prefer item 4 and user B will also prefer item 1.

In some aspects, collaborative filtering process(es) herein may generally include a two-step process. A first step includes determining a similarity between users. This step might be implemented using similarity metrics. A second step includes providing a recommendation to a user (e.g., supplier) based on the preferences of other known similar users. The varied and diverse sets of data derived from numerous different types of document files related to users disclosed herein and used in a collaborative filtering process provides a mechanism to generate well-matched recommendations.

In some embodiments, a first step of a collaborative filtering process uses a user-to-user (i.e., user-user) matrix or mapping function to track and record matching pairs of users determined to be similar to each other. In some embodiments, similarities in the documents files related to subject users, including the textual terms therein, may be used to determine a similarity between the sets of document files relating to the users. The determined similarity between sets of document files may be correlated to similarities between the users related to the respective sets of document files.

In some embodiments, one or more different similarity metrics or measures might be used in determining similarities in the data (e.g., document files) related to the users of a network. Some similarity measures that may be used in some embodiments include, for example, a Jaccard similarity that is calculated based on the number of users that have, for example, rated item A and B divided by the number of users that have rated either A or B. This type of similarity measure might be useful in a situation where a numeric or relative value is not known but rather a Boolean value representative of whether an event has occurred (e.g., user selected bought a commodity/service, a user selected an online advertisement, etc.). Another similarity metric that might be used in some embodiments herein includes cosine similarity metric, where the similarity is determined based on the cosine of the angle between two vectors of, for example, the item vectors for users A and B. With this similarity metric, the closer the vectors then the smaller the angles therebetween and the larger the cosine. Yet another similarity metric that may be used in some embodiments herein includes the Pearson correlation coefficient of two vectors. It is noted that other similarity metrics or measures may be viable and applicable in some contexts and applications of the one or more embodiments disclosed herein.

Returning to process 400 in FIG. 4, operation 420 includes generating an indicator that indicates a level to which the second set of document files (e.g., user profile document, query response document, interaction document, interest level document, a similarity level document, and other related historical documents) related to a second user is similar to the one or more documents in the first set of document files related to a first plurality of users.

Process 400 continues at operation 425 where a user interface to display the generated indicator for the second set of document files is output or otherwise presented to the second user. In some embodiments, the generated indicator may be configured as a numeric score on a predefined scale (1 to 100, 1 to 10, 1 to 5, etc.) and be labeled or referred to as a prediction score, a favorability score, and the like. In some embodiments, the presented user interface might include a “dashboard” including one or more graphic visualizations, a report, a listing, etc. The generated recommendation may be recorded and stored for further processing and/or reporting purposes.

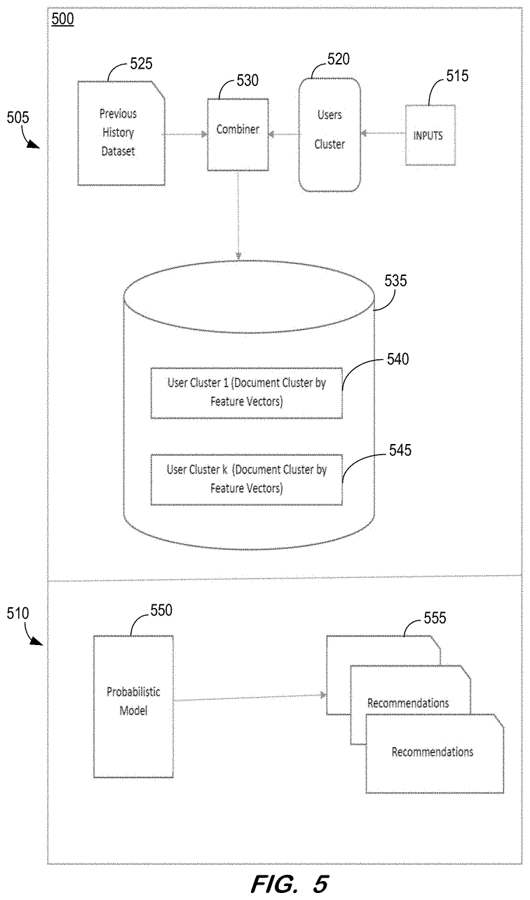

In some embodiments, a recommendation engine herein may be implemented in a combination of software and hardware modules. FIG. 5 is an illustrative depiction of a system architecture 500 for a recommendation engine, in one embodiment herein. The system includes a design time module or environment 505 where a diverse variety of document file inputs 515 disclosed herein can be used to create one of more clusters 520 for classifying users (e.g., suppliers). Additionally, previous historical data 525 (e.g., interaction document files related to previous transactions) for a plurality of users can be combined with input documents files 515 by a combiner 530. The combined data from combiner 530 may be used to determine, by a collaborative filtering process using a similarity metric that determines similarity between document files based on feature vectors of the document files, clusters 540 and 545 to which specific users will be assigned based on the similarity of their related document files with other users' document files. In some embodiments, clusters 540 and 545 may be meta-clusters offering a better fit than the clusters 520. System 500 also includes a run time module or environment 510 that executes and uses a conditional probabilistic model 550 to generate recommendations 555. In some embodiments, a recommendation is generated for a given user (e.g., supplier), where the recommendation may be a lead or invitation to contact another user (e.g., a buyer) enrolled in a professional network with the specific user.

In some aspects, the design time module or environment 505 comprises an off-line phase that includes the clusters and meta-clusters, where the meta-clusters may reduce a computational complexity associated with the process and further enable scalability. In some aspects, run time module or environment 510 comprises an on-line phase that uses (i.e., executes) the conditional probabilistic model 550 to generate the recommendations (e.g., preference predictions) 555. In combination, a user preference pattern can be calculated in the memory-based off-line phase and a recommendation for the user can be calculated during the model-based on-line phase.

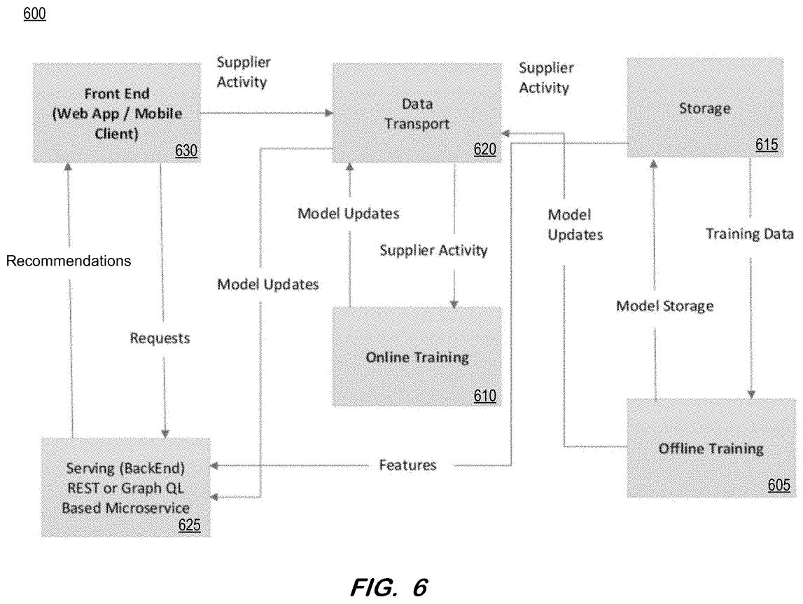

FIG. 6 is an illustrative system block diagram of a system 600 for implementing at least some of the methods and other aspects disclosed herein, according to some embodiments. In some embodiments, FIG. 6 illustrates some of the system architecture disclosed in FIG. 5 in that offline training module 605 may correspond to design time module or environment 505 and online training module 610 might correspond to some aspects of run time module or environment 510. FIG. 6 further demonstrates some information flow and communication between the functional blocks therein. For example, offline training module 605 receives training data (e.g., inputs including a variety of document files and representations thereof) from storage device 615, where the storage device might be any form or configuration of data storage, including a data stream. The training data is used to define and train a model that can be used to generate recommendations. The trained model may be stored in data storage 615. The online training module 610 may execute the (probabilistic) model during a runtime or online phase based on user (e.g., supplier) activity that is communicated, via transport module or layer 620, from storage 615 and a front end system 630 interfacing with a user. Moreover, a recommendation generated by the execution of the model by online training module 610 can be transmitted via transport module or layer 620 from the online training module to a backend system 625 providing or otherwise supporting a recommendation system, service, or platform, in accordance with other aspects disclosed herein. In some aspects, backend system 625 includes a server for replying to requests or queries from a user at frontend system 630 (e.g., a web app or mobile device client) with recommendation(s) for the user. In some aspects, the model(s) used in determining a recommendation by a recommendation herein may evolve and be updated as additional document files and other data are processed, in a form of machine learning. Accordingly, model updates are depicted in FIG. 6 as being communicated from both the offline and online training modules 605 and 610 the backend system via the transport module 620 so that the backend server can provide a recommendation based on the most accurate, updated, and complete data available and accessible to system 600.

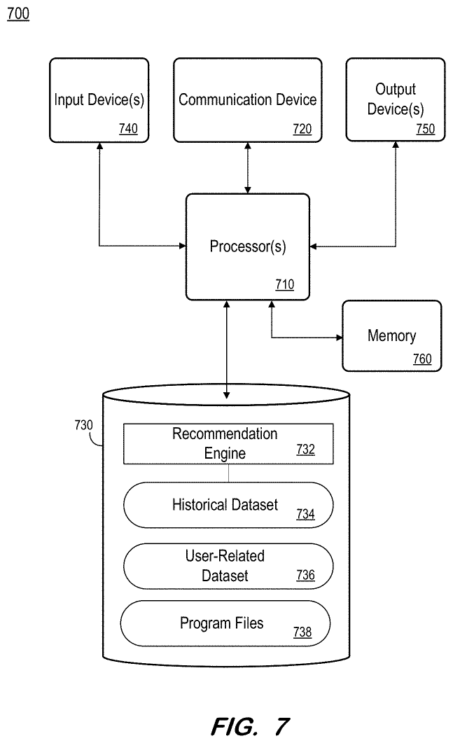

FIG. 7 is a block diagram of computing system 700 according to some embodiments. System 700 may comprise a general-purpose or special-purpose computing apparatus and may execute program code to perform any of the methods, operations, and functions described herein. System 700 may comprise an implementation of one or more elements of system architecture 500 and system 600. System 700 may include other elements that are not shown, according to some embodiments.

System 700 includes processor(s) 710 operatively coupled to communication device 720, data storage device 730, one or more input devices 740, one or more output devices 750, and memory 760. Communication device 720 may facilitate communication with external devices, such as a data server and other data sources. Input device(s) 740 may comprise, for example, a keyboard, a keypad, a mouse or other pointing device, a microphone, knob or a switch, an infra-red (IR) port, a docking station, and/or a touch screen. Input device(s) 740 may be used, for example, to enter information into system 700. Output device(s) 750 may comprise, for example, a display (e.g., a display screen) a speaker, and/or a printer.

Data storage device 730 may comprise any appropriate persistent storage device, including combinations of magnetic storage devices (e.g., magnetic tape, hard disk drives and flash memory), optical storage devices, Read Only Memory (ROM) devices, etc., while memory 760 may comprise Random Access Memory (RAM), Storage Class Memory (SCM) or any other fast-access memory.

Recommendation engine 732 may comprise program code executed by processor(s) 710 (and within the execution engine) to cause system 700 to perform any one or more of the processes described herein (e.g., process 400). Embodiments are not limited to execution by a single apparatus. Historical dataset 734 may comprise interaction document files and representations thereof including database tables and other data structures, according to some embodiments. Data storage device 730 may also store document files in user-related dataset document database 736, as well as data and other program code 738 for providing additional functionality and/or which are necessary for operation of system 700, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a processor; and
a memory in communication with the processor, the memory storing program instructions, the processor operative with the program instructions to perform the operations of:
receiving a first set of document files comprising textual terms relating to a plurality of first users from a data storage device;
receiving a second set of document files relating to a second user from one or more data sources, the second set of document files including a plurality of textual terms associated with the second user from a combination of documents including a user profile document, a query response document, an interaction document, an interest level document, and a similarity level document;
determining whether the second set of document files is similar to one or more documents in the first set of document files based on a collaborative filtering process of the textual terms derived from the second set of document files in combination with the textual terms of the first set of document files;
generating an indicator that indicates a level to which the second set of document files is similar to the one or more documents in the first set of document files; and
outputting a user interface displaying to the second user the generated indicator for the second set of document files.

2. A system according to claim 1, wherein the first set of document files are represented as a first set of database tables and the second set of document files are represented as a second set of database tables.

3. A system according to claim 1, wherein the processor correlates a similarity between the second set of document files and the one or more documents in the first set of document files to a similarity between the second user and at least one of the plurality of first users.

4. A system according to claim 1, wherein the collaborative filtering process further comprises:
determining one or more cluster groupings; and
generating, by the processor based on a combination to the determined cluster groupings and the first set of document files, one or more meta-cluster groupings.

5. A system according to claim 4, wherein the generating of the indicator is based on a conditional probability model and the meta-cluster groupings.

6. A system according to claim 4, wherein the similarity is determined using similarity metrics.

7. A system according to claim 1, wherein the second set of document files relate to a plurality of second users, each document file including an identifier of a specific user.

8. A non-transitory computer readable medium having executable instructions stored therein, the medium comprising:
instructions to receive a first set of document files comprising textual terms relating to a plurality of first users from a data storage device;
instructions to receive a second set of document files relating to a second user from one or more data sources, the second set of document files including a plurality of textual terms associated with the second user from a combination of documents including a user profile document, a query response document, an interaction document, an interest level document, and a similarity level document;
instructions to determine whether the second set of document files is similar to one or more documents in the first set of document files based on a collaborative filtering process of the textual terms derived from the second set of document files in combination with the textual terms of the first set of document files;
instructions to generate an indicator that indicates a level to which the second set of document files is similar to the one or more documents in the first set of document files; and
instructions to output a user interface displaying to the second user the generated indicator for the second set of document files.

9. A medium according to claim 8, wherein the first set of document files are represented as a first set of database tables and the second set of document files are represented as a second set of database tables.

10. A medium according to claim 8, wherein the processor correlates a similarity between the second set of document files and the one or more documents in the first set of document files to a similarity between the second user and at least one of the plurality of first users.

11. A medium according to claim 8, wherein the collaborative filtering process further comprises:
determining one or more cluster groupings; and
generating, by the processor based on a combination to the determined cluster groupings and the first set of document files, one or more meta-cluster groupings.

12. A medium according to claim 11, wherein the generating of the indicator is based on a conditional probability model and the meta-cluster groupings.

13. A computer-implemented method comprising:
receiving, by a processor, a first set of document files comprising textual terms relating to a plurality of first users from a data storage device;
receiving, by the processor, a second set of document files relating to a second user from one or more data sources, the second set of document files including a plurality of textual terms associated with the second user from a combination of documents including a user profile document, a query response document, an interaction document, an interest level document, and a similarity level document;
determining, by the processor, whether the second set of document files is similar to one or more documents in the first set of document files based on a collaborative filtering process of the textual terms derived from the second set of document files in combination with the textual terms of the first set of document files;
generating, by the processor, an indicator that indicates a level to which the second set of document files is similar to the one or more documents in the first set of document files; and
outputting, by the processor, a user interface displaying to the second user the generated indicator for the second set of document files.

14. A method according to claim 13, wherein the first set of document files are represented as a first set of database tables and the second set of document files are represented as a second set of database tables.

15. A method according to claim 13, wherein the processor correlates a similarity between the second set of document files and the one or more documents in the first set of document files to a similarity between the second user and at least one of the plurality of first users.

16. A method according to claim 13, wherein the first set of document files include historical data related to the plurality of first users.

17. A method according to claim 13, wherein the collaborative filtering process further comprises:
determining one or more cluster groupings; and
generating, by the processor based on a combination to the determined cluster groupings and the first set of document files, one or more meta-cluster groupings.

18. A method according to claim 17, wherein the generating of the indicator is based on a conditional probability model and the meta-cluster groupings.

19. A method according to claim 17, wherein the similarity is determined using similarity metrics.

20. A method according to claim 13, wherein the second set of document files relate to a plurality of second users, each document file including an identifier of a specific user.
